(19) United States
(12) Patent Application Publication
(10) Pub. No.: US 2005/0206090 A1
(43) Pub. Date: Sep. 22, 2005

(54) Multiple chamber rotating shaft seal with selective pressure reduction

(76) Inventor: Jack Bunn, Houma, LA (US)

Correspondence Address: BACON & THOMAS, PLLC, 625 SLATERS LANE, FOURTH FLOOR, ALEXANDRIA, VA, 22314, US

(21) Appl. No.: 11/127,138

(22) Filed: May 12, 2005

Related U.S. Application Data
(63) Continuation-in-part of application No. 10/455,381, filed on Jun. 6, 2003.

(51) Int. Cl. F16J 15/32

(52) U.S. Cl. 277/549

(57) ABSTRACT

A seal balancing arrangement for a rotating or reciprocating shaft used in a high pressure and/or high velocity environment includes a plurality of grease balancing chambers each bordered by a pair of seals and filled with extreme pressure grease. The grease is compressed between the additional grease chambers by the movement of the first seal due to pressure acting on this seal by system internal pressures, thereby reducing pressure on the first seal while distributing the pressure between the remaining seals. The balancing chambers are arranged such that the grease in between the seals can be replenished through ports provided in a supporting housing, thereby extending the life of the seal assembly by allowing grease to lubricate the seal faces by extruding grease from each grease chamber. The seals may include a combination of stationary and floating seals, with the floating seals having different surface areas and optionally being connected by a piston, to vary the pressure in corresponding balancing chambers.

This application is a continuation-in-part of U.S. patent application Ser. No. 10/455,381, filed Jun. 6, 2003.

### BACKGROUND OF THE INVENTION

1. Field of the Invention

This invention relates to a rotating shaft seal, and in particular to an improvement on the multiple chamber, rotating shaft seal described in parent application Ser. No. 10/455,381. According to the improvement, the uniformly-sized seals and chambers described by way of example in the parent application are replaced by floating seals of various sizes arranged to reduce overall pressure in adjacent chambers, and therefore increase the life of downstream seals while at the same time reducing pressure on upstream seals by generating a balancing back-pressure on the downstream side of the upstream seals.

The system and method of the invention may be used in a variety of rotary swivel and top drive drilling applications, as well as in reciprocating drive applications, in a variety of technical fields ranging from oil drilling to aerospace and medical devices.

2. Description of Related Art

When seals between a rotary or reciprocating shaft and a housing are subject to a high pressure medium such as drilling mud, and/or the shaft rotates or reciprocates at a high velocity, failure of the seals occurs relatively quickly. In order to extend the life of the seals it is possible to reduce the net pressure on, at least, the upstream seal that faces the pressure-applying medium by generating a back pressure on the downstream side of the seal.

This is conventionally accomplished by diverting the source of the external high pressure, such as drilling mud, past one side of the seal through, for example, a labyrinth seal, so as to provide a fluid pressure on the opposite side of the seal that is substantially the same as the fluid pressure on the first side of the seal. The fluid pressure caused by the diverted drilling mud or other fluid may then be transferred through a lubricant-filled chamber to a piston that expands the chamber in response to pressure on the bearing seal, and by adding a lubricant source to replace lost lubricant. Examples of this type of pressure-equalization arrangement are found in U.S. Pat. Nos. 4,225,000, 4,324,299, 4,325,299, and 4,548,283. Although effective to relieve pressure, this type of sealing arrangement is relatively costly to implement.

Alternative to use of fluid diversion, particular when the pressure-applying medium is abrasive and non-lubricating, is to use multiple floating barrier lip seals and a lubricant-filled chamber to directly transfer pressure away from the upstream seal that faces the source of fluid pressure. For example, in an arrangement proposed by Bal Seal Engineering Co. Inc., pressure applied by a fluid on a first floating barrier lip seal, is transferred by a medium such as lubricating fluid to a second floating barrier lip seal, which is surrounded by good lubricating media. Since the rear or downstream seal may be optimally lubricated it is capable of resisting differential pressure, while the first seal is pushed into equilibrium and therefore less subject to wear by the more abrasive pressure-applying fluid. In addition, in the sealing arrangement proposed by the Bal Seal company, some configurations have a third seal, rear facing, which is back-to-back with the second seal to give bi-directional sealing at a rear seal position.

The Bal Seal arrangement is much simpler than the arrangement described in the above-cited patents, and is especially suitable for applications in which complete isolation is required, such as downhole drilling applications. However, the arrangement only relieves pressure on the upstream seal that is exposed to the abrasive pressure-applying media. All of the pressure is transferred to the downstream seal through a single lubricant chamber. As a result, the lifetime of the seals is still less than optimal. In addition, failure of either seal leaves the other seal exposed to maximum pressure as well as to the abrasive media, which can have catastrophic results.

In parent application Ser. No. 10/455,381, it was proposed to replace the fluid diversion of the prior art and/or the Bal Seal arrangement with a multiple seal arrangement utilizing multiple grease-filled chambers to directly transfer pressure from seal to seal, thus distributing pressure across multiple seals, and avoiding reliance on a single pair of seals so as to greatly reduce the possibility of catastrophic failure. However, the downstream or back seal in this arrangement is still subject to overheating and seal failure due to excess pressure, leading to disintegration. To solve this problem, the present invention therefore modifies the multiple-chamber seal balancing concept of parent application Ser. No. 10/455,381 by varying the sizes of the seals and chambers so as reduce pressure or force transmitted to the downstream or back seal. The use of different seal sizes to reduce pressure in effect combines the multiple chambers described in the copending application with a pressure-reducing floating seal arrangement to achieve selective reduction in the overall pressure to which the back seals are subject, while still maintaining back-pressure on the upstream seals.

### SUMMARY OF THE INVENTION

It is accordingly a first objective of the invention to provide a seal arrangement for high pressure rotary swivel or top drive systems, or reciprocating systems, that includes a direct self-balancing design to allow the seals to operate under high pressure and high velocity conditions without flow diversion or continuous replacement of a pressurizing medium.

It is a second objective of the invention to provide a system and method of sealing a rotating or reciprocating shaft that not only balances pressure on the upstream, high pressure seal (s), but that also reduces pressure on the downstream seal(s).

It is a third objective of the invention to provide a system and method of sealing a rotating or reciprocating shaft that provides a degree of redundancy to reduce the chance of catastrophic failure upon breach of one of the seals.

It is a fourth objective of the invention to provide a system and method of sealing a rotating or reciprocating shaft by using multiple balancing chambers, and which nevertheless provides increased design flexibility to reduce the net pressure and/or force applied to selected seals.

In accordance with the principles of a preferred embodiment of the invention, seal balancing is accomplished, as in the copending parent application, by providing multiple grease-filled balancing chambers with common seals that distribute pressure between chambers while maintaining a back pressure that balances the pressure on the upstream side of the seals, and in which different seal sizes are used to reduce the pressure on the back seals by reducing the overall pressure in the downstream chambers. As in the system described in the parent application, system pressure is initially applied to a barrier seal that seals the harsh contaminants from the other seals in the system, thereby compressing the first grease pack. By compressing the first grease pack and placing a balancing pressure on the back side of the barrier seal so the seal lip is in balance and does not see the full system pressure exerted on the lip of the seal.

Unlike the seal balancing system of the parent application, however, instead of distributing the pressure to identical grease filled chambers, the present invention provides for the addition of at least one pressure reduction chamber, or multiple chambers arranged to progressively decrease transmitted force, thereby reducing pressure or force on the downstream seals. This may be accomplished in a variety of ways, including:
(i) arranging the pressure-reduction chamber to have a larger diameter and therefore a greater seal area, and connecting the balancing and pressure-reduction chambers by a stepped seal carrier;
(ii) arranging the pressure-reduction chamber to have a larger diameter and separating the chambers by floating seals with correspondingly varied diameters; and/or
(iii) arranging the successive balancing chambers to have smaller diameter in order to reduce the force transmitted to downstream chambers.

### BRIEF DESCRIPTION OF THE DRAWINGS

FIG. 1 is a cross-sectional view of the seal balancing system described in parent U.S. patent application Ser. No. 10/455,381.

FIG. 2 is a cross-sectional view of a preferred variant of the seal balancing system illustrated in FIG. 1, which utilizes a stepped seal carrier and enlarged diameter pressure reduction chambers to reduce pressure on downstream seals.

FIG. 3 is a cross-sectional view of a second preferred variant of the seal balancing system illustrated in FIG. 1, in which the stepped seal carrier is replaced by floating seals separated by an intermediate balancing chamber.

FIG. 4 is a cross-sectional view of a third preferred variant of the seal balancing system illustrated in FIG. 1, but in which diameters of the chambers are progressively decreased to reduce force transmission to stationary downstream or back seals.

### DETAILED DESCRIPTION OF THE PREFERRED EMBODIMENTS

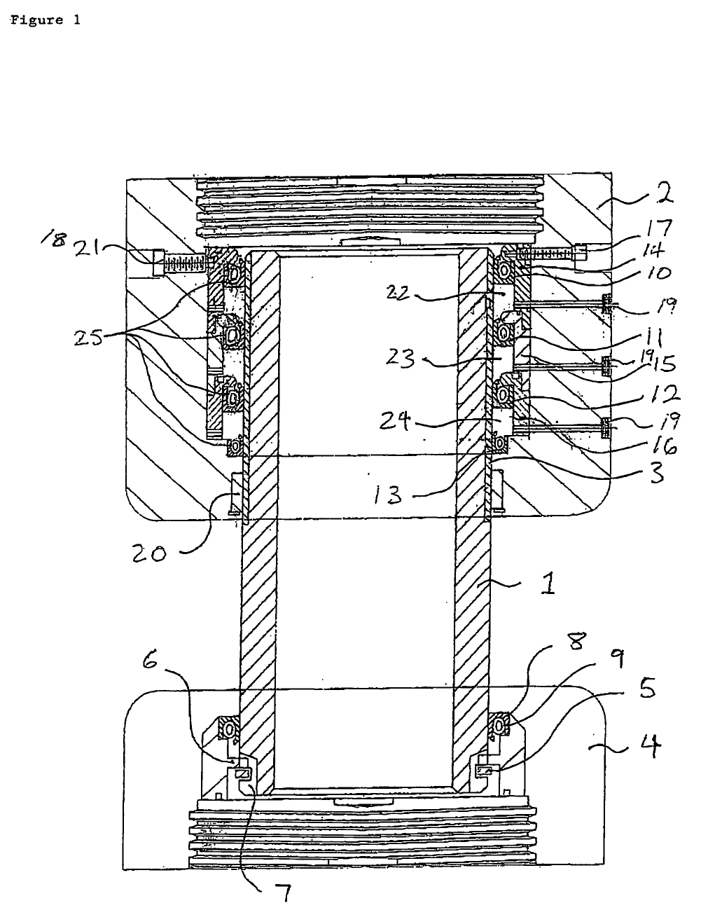

The present invention utilizes the seal balancing principles described in U.S. patent application Ser. No. 10/455,381, and illustrated in FIG. 1.

In the seal balancing arrangement of FIG. 1, one end of the shaft 1 includes a wear sleeve 3 for engagement with an alignment bushing 20 on the stationary or non-rotary assembly 2, while the other end of shaft 1 is secured to a coupling structure 4 by a pin 5, slot 6, snap ring 7 and floating lip seal 8 with a captivated resilient member 9. It will be appreciated, however, that the shaft 1, coupling structure 4, pin 5 and slot 6, snap ring 7, seal 8, and related structures form no part of the present invention and may be freely varied by those skilled in the art, and that the invention may be adapted for use in connection with a wide variety of shaft and housing structures for high pressure rotary swivel or top drive systems, including systems designed for use in land, inland barge, offshore drilling, or production platform facilities, as well as in other contexts involving high pressure rotary, swivel, or reciprocating drive systems.

In order to provide a self-balancing seal, the shaft sealing system of the preferred embodiment includes a plurality of annular seals 10-13 surrounding the shaft 1. In addition, the illustrated stationary or non-rotary assembly 2 includes a plurality of annular seal supporting structures 14-16 held in place by screws 17 and 18 for supporting and limiting upward movement of seals 10-13 upon application of pressure. Respective first, second, and third annular chambers 22-24 are formed between the supporting structures 14-16 and wear sleeve 3, and between the respective seals 10-13. Chambers 22-24 are filled with an extreme pressure grease of a type that is known to those skilled in the art and commercially available. Each chamber communicates with an outside of the housing 2 by means of a respective grease service port 19 that permits the grease to be replenished.

The seal balancing is accomplished by compressing the extreme pressure grease in between the first, second, and third grease chambers 22-24 by the movement of seals 10-12 due to pressure acting on these seals by system internal pressures. The grease in chambers 22-24 between the seals can be replenished through the provided ports 19, extending the life of the seal assembly by allowing the grease to lubricate the seal faces by extruding grease from each grease chamber.

Seals 10-13 are preferably floating barrier lip seals, although one or more of the seals may be replaced by functionally equivalent types of seals depending on the specific application, or additional seals such as o-rings may be added either downstream or upstream of the main seals. Even if the same type of seal is used for each of seals 10-13, the seals may have different dimensions. If floating barrier lip seals are used, the floating barrier lip seals may be short or full lip, and may including a U-cup in which is placed a resilient member 25, such as a canted or standard coil spring, finger type energizing elements, and so forth.

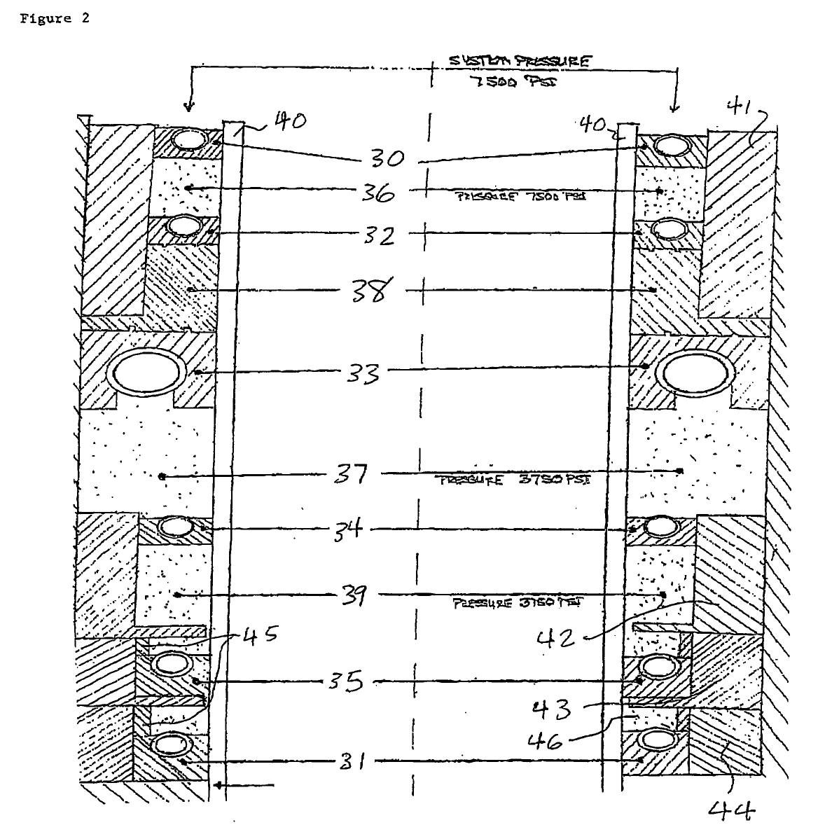

FIG. 2 shows a variation of the seal balancing system of FIG. 1, in which the outside seals are a barrier seal 30 on the upstream side, and a stationary seal 31 on the downstream side, and the interior seals include, in order from the upstream side to the downstream side, a first floating seal 32, a second floating seal 33, and third floating seal 34, and another stationary seal 35. The second floating seal 33 is relatively larger in comparison with the first floating seal 32, such that a contact area of first floating seal 32 and a first grease pack 36 is smaller than a contact area of second floating seal 33 with second grease pack 37, thereby reducing a pressure on the second grease pack 37, the third floating seal 34, a fourth grease pack 39, and stationary seals 35 and 31. In addition, the first and second floating seals are connected to a seal carrier 38 having an L-shape to accommodate the larger second floating seal 33.

As in the sealing arrangement of FIG. 1, the illustrated rotating shaft seal includes a wear sleeve 40 and supporting structures 41-44 arranged to define the respective chambers, which are preferably filled with an extreme pressure grease of the type discussed above in connection with FIG. 1. Furthermore, as in the arrangement of FIG. 1, the floating seals may include a cup-shape in which is positioned a resilient member such as a coil spring, and grease service ports (not shown) may also be provided. Optional shims or inserts 45 serve to capture stationary seals 31 and 35 and reduce the size of chambers 38 and 46 in order to further reduce the force transmitted to stationary seal 31 as a result of the small area of seal 35 that is affected by the transmitted pressure.

As described above in connection with the arrangement of FIG. 1, pressure applied to the barrier seal 30 which seals the harsh contaminants from the other seals compresses the first grease pack 36. By compressing the first grease pack 36 by the system pressure, a balancing pressure is exerted on the back side of the barrier seal 30 so that the seal lip is in balance and does not see the full system pressure exerted on the lip of the seal. This insures long life of the barrier seal 30 due to the balancing pressure created by compressing the grease in the chamber containing the first grease pack 36, which is at the system pressure.

Since the second floating seal 33 has twice the surface area of the first floating seal 32, however, the pressure applied to the grease in the chamber containing the second grease pack 37 will be 50% of the pressure applied to the first grease pack 36. For example a pressure of 7500 PSI on the first barrier seal 30 will initially be transmitted to the first floating seal 31, and thence to the seal carrier 38. The pressure transmitted to the second grease pack 37 and the third floating seal 34 will only be 3750 PSI. This lower pressure is transferred to the lower grease pack 39, and to the stationary seals 31 and 35.

Those skilled in the art will appreciate that the illustrated seal diameters and numbers of chambers/grease packs is by way of example only, and that the sizes and numbers may be varied as necessary to achieve a desired pressure reduction effect without departing from the principles of the invention. For example, the arrangement for reducing pressure on the stationary back seals can be used to achieve an arbitrary pressure reduction by varying the ratio of surface areas on each side of the stepped seal carrier, and/or by varying the number of seal carriers and floating seals of different sizes.

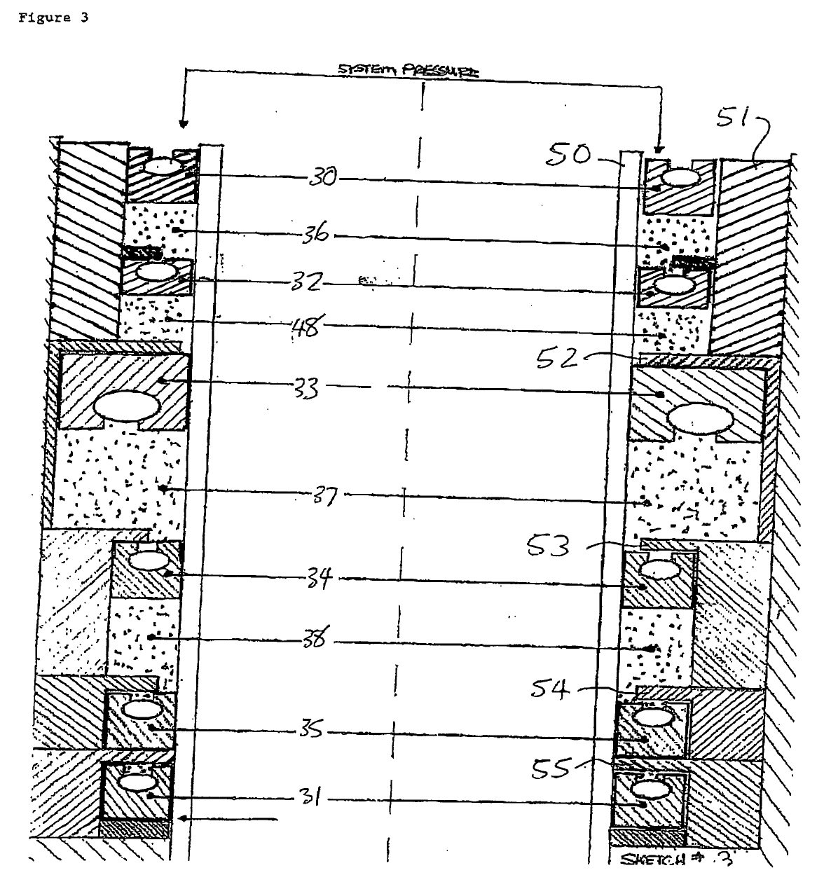

FIG. 3 shows a variation of the embodiment illustrated in FIG. 2, in which the same pressure reduction effect is achieved by replacing the stepped seal carrier or piston with an intermediate grease pack 48 between floating seals 32 and 33. Again, because seal 33 has a 50% larger area than seal 32, the pressure in the chamber containing grease pack 37 is reduced by 50%, thereby reducing pressure on the downstream seals 34, 35, and 31.

As in the embodiment of FIG. 2, a wear sleeve 40 and supporting structures 51-55 are arranged to define the respective chambers, the only difference being that the supporting structures are configured to accommodate the additional grease chamber and compensate for the lack of the stepped seal carrier. Optionally, the grease pack 46 separating the seals in the embodiment of FIG. 2 has been omitted in the embodiment of FIG. 3. Those skilled in the art will appreciate that the configurations of the stationary seals, supporting structures, floating seals, and the like may be identical to those included in the arrangement of FIG. 2, or varied as necessary to achieve a desired pressure reduction effect.

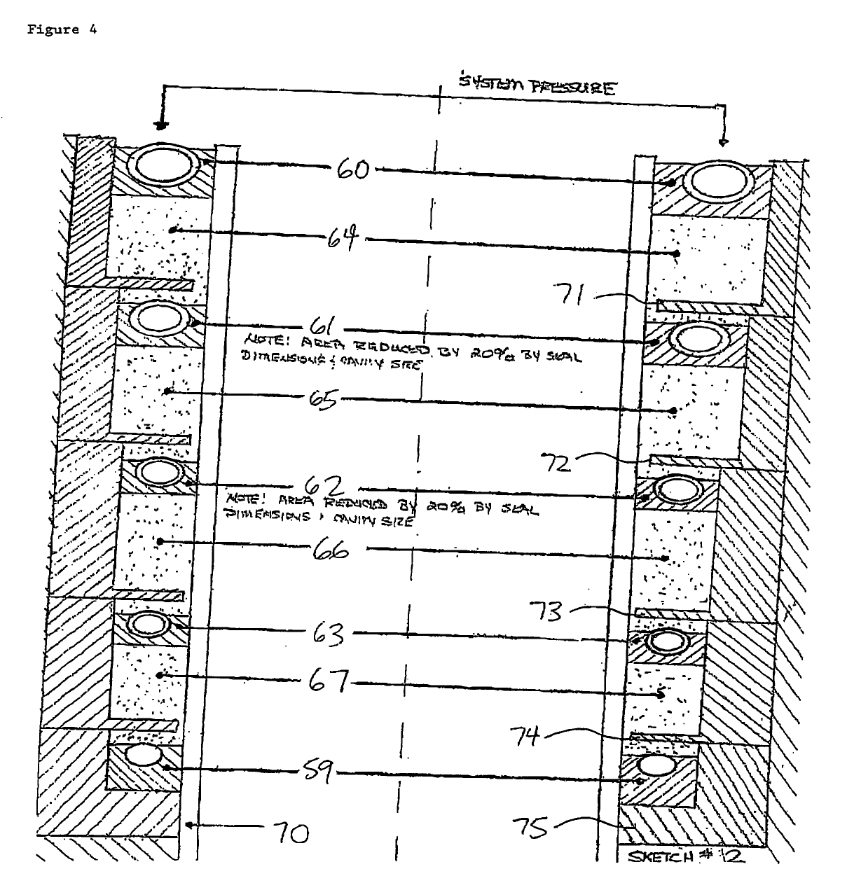

In the embodiment illustrated in FIG. 4, on the other hand, force on the stationary back seal 59 is controlled by progressively decreasing the sizes of successive chambers in order to reduce the amount of force transmitted via the respective seals 60-63 and grease packs 64-67 situated between wear sleeve 70 and supporting structures 71-75.

As in the embodiment of FIG. 2, pressure on the barrier seal 60 is transmitted directly to a first grease pack 64, which maintains the system pressure and exerts a corresponding back pressure on the first barrier seal 60. However, the first floating seal 61 has an area that is 20% less than that of the barrier seal 60 and, as a result, transmits less force to the second floating seal 62. The excess force instead adds to the back pressure on the barrier seal to increase the balancing back pressure on the first floating seal 61. Similarly, the second floating seal 62 and third floating seal 63 each has an area that is reduced by 20% relative to the area of the respective upstream seal, further decreasing the force to the respective grease packs 66 and 67, and to the downstream stationary seal 59.

Having thus described various preferred embodiments of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

1. A balanced seal arrangement for high pressure rotary or reciprocating systems including a rotary or reciprocating shaft and a stationary assembly relative to which the shaft rotates or reciprocates, comprising:
a first balancing chamber bordered by a barrier seal and a first floating seal, a second balancing chamber bordered by said second floating seal and a third floating seal, each balancing chamber being situated between the shaft and the stationary assembly, and each balancing chamber being filled with a lubricant, wherein the lubricant is compressed in between the additional balancing chambers by the movement of the first seal due to pressure acting on this seal by system internal pressures,
wherein said first floating seal has a surface area that is different that said second floating seal, thereby causing a pressure drop between said lubricant in said first balancing chamber and said lubricant in said second balancing chamber.

2. A balanced seal arrangement as claimed in claim 1, wherein a surface area of said second floating seal is greater than a surface area of said first floating seal.

3. A balanced seal arrangement as claimed in claim 2, further comprising an intermediate balancing chamber between said first and second floating seals.

4. A balanced seal arrangement as claimed in claim 2, further comprising a stepped seal carrier connecting said first and second floating seals.

5. A balanced seal arrangement as claimed in claim 1, further comprising an intermediate balancing chamber between said first and second floating seals.

6. A balanced seal arrangement as claimed in claim 1, wherein said second floating seal has a smaller surface area than said first floating seal.

7. A balanced seal arrangement as claimed in claim 6, further comprising a third floating seal and a balancing chamber situated between said second and third floating seals, wherein said third floating seal has a smaller surface area than said second floating seal.

8. A balanced seal arrangement as claimed in claim 1, further comprising at least one stationary seal and a balancing chamber situated between said stationary seal and a third floating seal.

9. A balanced seal arrangement as claimed in claim 1, further comprising a second stationary seal and a balancing chamber situated between said first and second stationary seals.

10. A balanced seal arrangement as claimed in claim 1, wherein the lubricant is extreme pressure grease.

11. A balanced seal arrangement as claimed in claim 10, wherein said floating seals have a cup-shape in which is positioned a resilient member.

12. A balanced seal arrangement as claimed in claim 11, wherein the resilient member is a coil spring.

13. A balanced seal arrangement as claimed in claim 1, wherein the stationary assembly and shaft are part of a rotary swivel or top drive system for an oil drilling rig.
